(19) United States
(12) Patent Application Publication
(10) Pub. No.: US 2011/0043636 A1
(43) Pub. Date: Feb. 24, 2011

(54) METHOD OF DETERMINING AN INTRUSION INTO A MONITORED AREA AND A SYSTEM THEREFORE

(76) Inventors: Zsombor Lazar, Budapest (HU); Mate Szalay, Budapest (HU); Peter Tarjan, Budapest (HU)

Correspondence Address: DOWELL & DOWELL P.C., 103 Oronoco St., Suite 220, Alexandria, VA, 22314, US

(21) Appl. No.: 12/865,004

(22) PCT Filed: May 22, 2008
(86) PCT No.: PCT/HU08/00057

§ 371 Date: Nov. 2, 2010

(30) Foreign Application Priority Data
Jun. 5, 2007 (HU) P0700391

(51) Int. Cl. H04N 7/18

(52) U.S. Cl. 348/155; 348/E07.085

(57) ABSTRACT

A method of determining an intrusion into a monitored area comprises the evaluation of images of specific optical pattern (40) arranged behind said monitored area. The system comprises at least two imaging devices (20) spaced from the plane of said monitored area; a predetermined optical pattern (40) positioned outside and behind said monitored area; at least two mirror (30) directing the images of said optical patterns (40) to said imaging devices (20); a processor receiving and processing image data provided by said at least two imaging devices (20) to detect any optical change and to determine the position of an intrusion causing optical change within said predetermined area; an output signal generator for generating an output signal depending on the relative position of said intrusion.

The object of the invention relates to a method of determining an intrusion into a monitored area as well as a system for generating at least one output signal in response to an intrusion into said monitored area, particularly for simulating a touch screen in conjunction with display windows for initiating different actions, if a bystander touches or almost touches a particular area of the window.

Similar solutions are known i.e. from US2004/012573 and US2004/069934. Such solutions comprise imaging devices arranged at different locations and each having a field of view covering a part of the monitored area. The imaging devices convey the captured image of the monitored area to a processor-based evaluating unit, which is designed to detect the relative position of an object present within said area.

A common drawback of such solutions is that the detection of an object within said area is not sufficiently reliable and to ensure safe detection delicate calibration operation have to be performed.

Another drawback of such solutions is that sensitive parts of the system are exposed to environmental influences including abuse.

The aim of the invention is to alleviate one or more of such drawbacks.

The aim set is achieved by a method of determining an intrusion into a monitored area by capturing images of at least two imaging devices positioned at a deferent locations relative to said area and having overlapping fields of view and by processing the captured images to detect change in the image to determine relative position of an object causing said change in the captured image of the predetermined pattern. Distinctive features of the method according to the invention are set forth in attached claim 1.

According to the invention also a system for generating at least one output signal depending on the relative position of an intrusion of an optically detectible object into a monitored area is provided. Said system comprises at least two imaging devices spaced from the plane of said monitored area, and having fields of view covering the whole monitored area; a processor receiving and processing image data provided by said at least two imaging devices to detect any optical change caused by the intrusion of said object into said monitored area and to determine the position of said intrusion causing optical change within said predetermined area; an output signal generator for generating at least one output signal depending on the relative position of said intrusion into said monitored area.

Distinctive features of the system according to the invention are set forth in attached claim 7. Preferred embodiments of such general solutions are defined by the attached dependent claims 2 to 6 and 8 to 13, respectively.

### BRIEF DESCRIPTION OF THE DRAWINGS

Further features and advantages of the invention will be explained in more details with reference to the attached drawings, wherein

FIG. 1 shows a display window fitted with various parts of the invented system;

FIG. 2 shows a mirror holder diverting the angle of view of an imaging device;

FIG. 3 shows a schematic diagram of the inventive system;

FIG. 4 shows an area of a shop-window bordered by an irregular quadrangle representing an area-projecting field of a projector;

FIG. 5 shows a quasi three dimensional arrangement of the inventive system,

FIG. 6 shows the front of a shop-window with a shade and provided with a quasi three dimensional version of the inventive system and

FIG. 7 shows the shop-window of FIG. 6 in cross section.

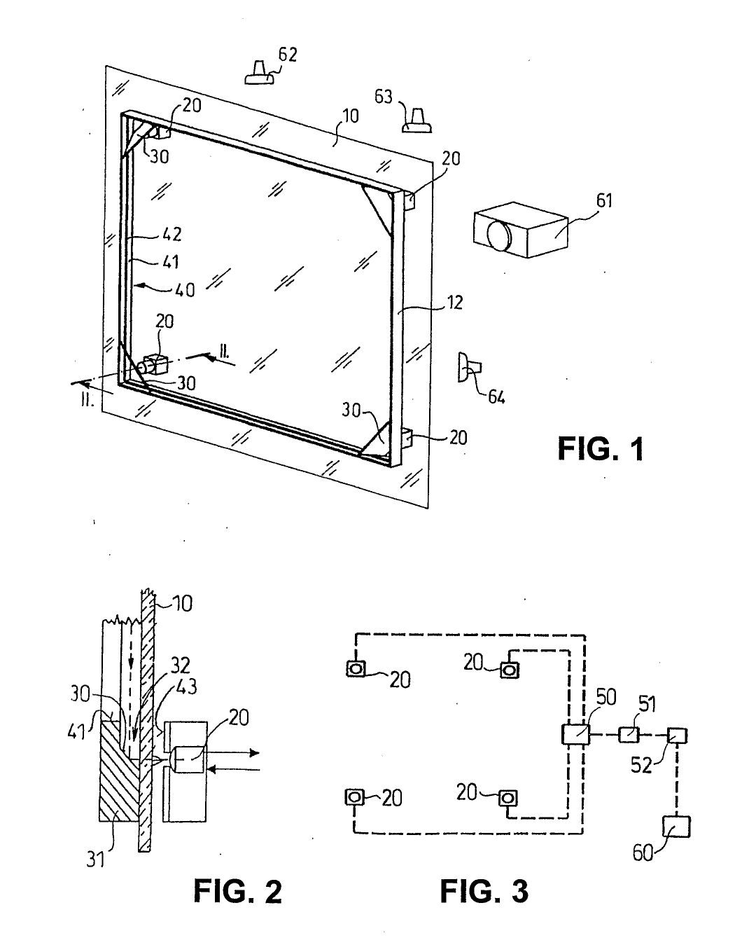

FIG. 1 shows a first embodiment of the inventive system adapted to a transparent sheet 10, such as a glass pane of a shop-window. This transparent sheet 10 has a peripheral area embedded in a frame structure 12 of the shop-window, not shown in the figure. This peripheral area does not have any function in the invented system. This transparent sheet separates a display area from the outside area. Outside said transparent sheet, an optical pattern 40 comprising e.g. a bright stripe 41 and a dark stripe 42 is arranged next to the plane defined by the outer surface of the transparent sheet 10. This optical pattern 40 can be applied to the frame structure 12 of the shop-window by adhering a pressure sensitive tape with appropriate pattern onto the inner side of the frame structure 12. In each of the four corners of the frame structure, a mirror 30 is arranged at an angle projecting to inner sides of the frame structure 12 to a respective one of four imaging devices 20 located at each of the four corners on the opposite side of said transparent sheet 10.

The operation of the system shown on FIG. 1 will be explained below by referring to FIG. 3.

Said four imaging devices 20 are connected to an image data acquisition controller 50. Said controller 50 provides all signals necessary to cause said imaging devices 20 to output image data with appropriate timing to the controller 50. Said controller 50 forwards received image data to an evaluation unit 51. Said evaluation unit evaluates optical changes in the forwarded image data, particularly any changes at the area close to the bright-dark transitions between said bright stripe 41 and dark stripe 42. Other parts of the image data are disregarded and thereby the evaluation is significantly simple and fast. The evaluation technique described in U.S. Pat. No. 6,803,906 can be used to determine the position of a touch of the outer surface of said transparent sheet. Actually, not the action of touch is detected but optical occultation or distortion of a section of said bright-dark transition caused by an intrusion of an object approaching the outer surface of said sheet 10 into a specific area within viewing field of an imaging device 20. This specific area is a narrow stripe next to said bright-dark transition.

To define the position of a single intrusion, theoretically two imaging devices 20 are needed. To improve reliability, however, redundant imaging devices 20 can be used. Using four imaging devices 20 as in embodiment of FIG. 1 positions of three distinct intrusions can be reliably defined by using trigonometric functions.

Said evaluation unit 51 receives image data from said imaging devices 20. The image data comprise essential groups of pixels characterising bright-dark transitions of said optical pattern 40. Said optical pattern 40 compulsory comprises such bright-dark transition having a longitudinal orientation and defining thereby a generally planar surface including all ray path between said transition and an optically sensitive surface of said imaging devices 20. This essentially planar surface theoretically is not planar because the optical centre of said imaging device 20 or its image as reflected by a mirror 30 lies outside a plane defined by two angled linear transition lines.

Said evaluation unit 51 monitors only an area next to the image of said transition. Detecting sudden change in transverse direction can reliably identify the position of said transition. Should a sudden change disappear from or move inside this monitored area then the position of such disturbance can be identified as an intrusion and position of said disturbance can be used as a parameter in known trigonometric functions to define the position of such intrusion relative to the positions of said imaging devices 20.

The use of bright-dark transition in the optical pattern 40 significantly facilitates elimination of the effect of various unwanted influences including fluctuation of illumination, such as alteration of sunlight and meteorological conditions, headlight of vehicles different illumination effects inside the display area behind the shop-window, etc. This insensitiveness allows use of illumination effects in response to detected intrusions.

Said evaluation unit 51 forwards data of occasional intrusions to an output control unit 52. This unit 52 compares data of an intrusion with data defining a particular monitored area and if the position of an intrusion falls within this area said unit 52 generates an output signal towards some kind of executive device. For example an intrusion is detected in the left half of the shop-window a spot lamp 62 located over said left half will be switched on or oppositely. At the same time a projector 61 may project information on a highlighted product in said left half of the display area to a mat area of the transparent sheet 10 or onto a projection screen. Depending on the resolution of the imaging devices 20 and an accuracy of said evaluation of intrusions a relatively high number of specific areas can be defined and data of such areas can be stored to be accessed by said output control unit.

To define one or more such monitored areas the system according to the invention should or can be calibrated. Knowing the exact position of imaging devices and the relative positions and orientations of said transition lines the position of each point within the common viewing area of said imaging devices can be calculated using mathematical transformations on the basis of trigonometric functions and using image data provided by said imaging devices 20. In the practice, however, it is sufficient to empirically define correlations between image data of some preferred points and their relative positions.

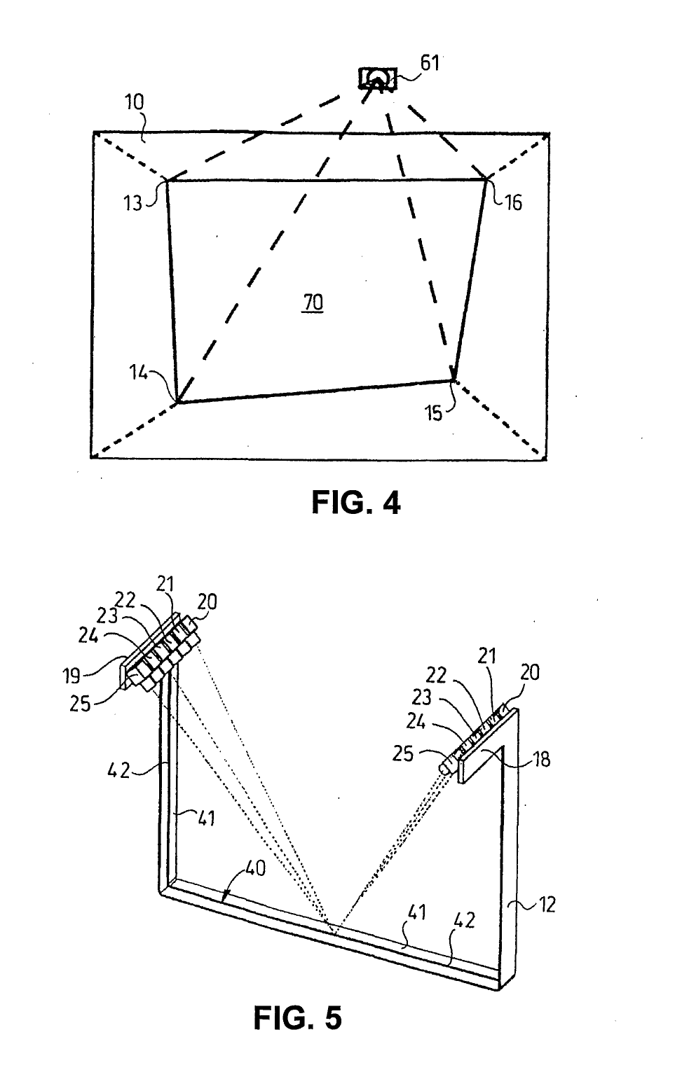

On FIG. 4 an irregular projecting screen 70 is shown in conjunction with a transparent sheet 10. A projector 61 is arranged to project information onto said screen 70. Said screen 70 has four corners 13, 14, 15 and 16. To calibrate the invented system four intrusions are generated successively at all four points 13, 14, 15 and 16. The evaluation unit 51 will output successively output data characteristic to the four corners 13, 14, 15 and 16 of said screen 70. Then several intrusions are generated within the area of said screen 70 e.g. by drawing an imaginary irregular line by a finger within the area of said screen 70. The calibration can be effected also in the opposite order as well. All the data provided by all imaging devices 20 relate to one and the same point of intrusion. This is an essential and primary condition to allow establishing correlations between the image data and the position of an arbitrary intrusion point. On the basis of such correlations e.g. regular geometric forms such as rectangles, circles, triangles, etc. or irregular areas can be defined within the area of said screen 70. In case of a shop-window such defined areas can be covered e.g. by a light diffusing foil while substantial part of the sheet 10 remains clear. Said projector 61 uses only these clouded areas for projecting any information or picture or video.

In a preferred embodiment of the invented system said mirrors 30 can be included into a mirror holder 31 arranged in the corners of said frame structure 12. FIG. 2 shows a possible preferred embodiment of such a mirror holder 31 in section seen in the direction marked by arrows II-II in FIG. 1. Such a mirror holder 31 can have a side surface bearing a bright stripe 41 facing another mirror holder 31 arranged in an other corner of said frame structure 12. Said mirror holder 31 has an indentation 32 shaped with an angled bottom either supporting or forming said mirror. In the latter case this angled bottom surface is appropriately finished to have a sufficiently reflecting optical surface. Such a mirror holder 31 protects said mirror 30 from unwanted influences and diverts the image of said optical pattern 41 to an imaging device 20 located in a protected position behind said transparent sheet 10 i.e. behind the glass pane of a shop-window. The imaging device 20 is hidden in a casing having a dark surface 43 on its front. Thereby said mirror reflects this dark surface 43 including a part of said imaging device 20 having a lens, the image of which is also dark. Using this structure, the bright stripe 41 applied to the inner side of said frame structure 12 continues on said mirror holder 31 and said dark stripe 42 converts into a dark image of said dark surface 43 and lens of said imaging device 20 as reflected by said mirror 30. The imaging device 20 arranged diagonally to said mirror holder 31 forwards image data comprising an almost continues and linear bright-dark transition that is easy to evaluate.

In the instant description the terms bright and dark represent surfaces exhibiting reflection coefficient differing at least 40% from each other at least in a wavelength range detected by said imaging device 20.

FIG. 5 shows another embodiment of the invented system wherein several imaging devices 20 to 25 are arranged on two consoles 18 and 19. Optical patterns 40 in form of a bright stripe 41 and a dark stripe 42 are applied onto the inner side of a frame 12. Said consoles 18 and 19 are connected to the upper part of said frame 12. Said imaging devices 20 to 25 on both consoles 18 and 19 are oriented to capture the image of said optical pattern 40 on the lower part of said frame and on the opposite inner side of said frame 12. The optical centre lines of said imaging devices 20 to 25 are directed to the centre of the lower part of said frame 12 as shown by straight lines on the figures. Imaging devices 20 are next to the plane defined by the transition between said bright stripe 41 and dark stripe 42. In case of a shop-window these imaging devices 20 are next to a transparent sheet 10 or glass plane of said shop-window while imaging devices 25 are the farthest ones. These farthest imaging devices 25 in conjunction with the transition line on the lower part of said frame 12 defines a triangular planar area and another triangular area in conjunction with the transition line on the opposite inner side of said frame 12. The remaining imaging devices 21 to 24 define further triangular planar areas closer to the plane defined by imaging devices 20 and the optical pattern 40 applied onto the inner side of said frame 12.

This arrangement allows a quasi three-dimensional detection of an intrusion by a limited perception of the distance between the intruding object and transparent sheet 12 not shown in this figure. In that case the evaluation unit 51 has to define not only the relative position of an accidental intrusion into a single plane, but several intrusions beginning from the farthest one. This is a somewhat more complex task, but does not necessitate particularly complex mathematical operations. The output control unit 52, however, may perform complex operations inducing various events inside the display area behind the shop-window that can be controlled by movements of a person standing before the shop window. This embodiment of the invented system can be completed with one or more optical patterns arranged on the pavement at a distance from the shop-window. For this purpose an appropriately coloured tape or a metal rail can be applied to the surface of the pavement.

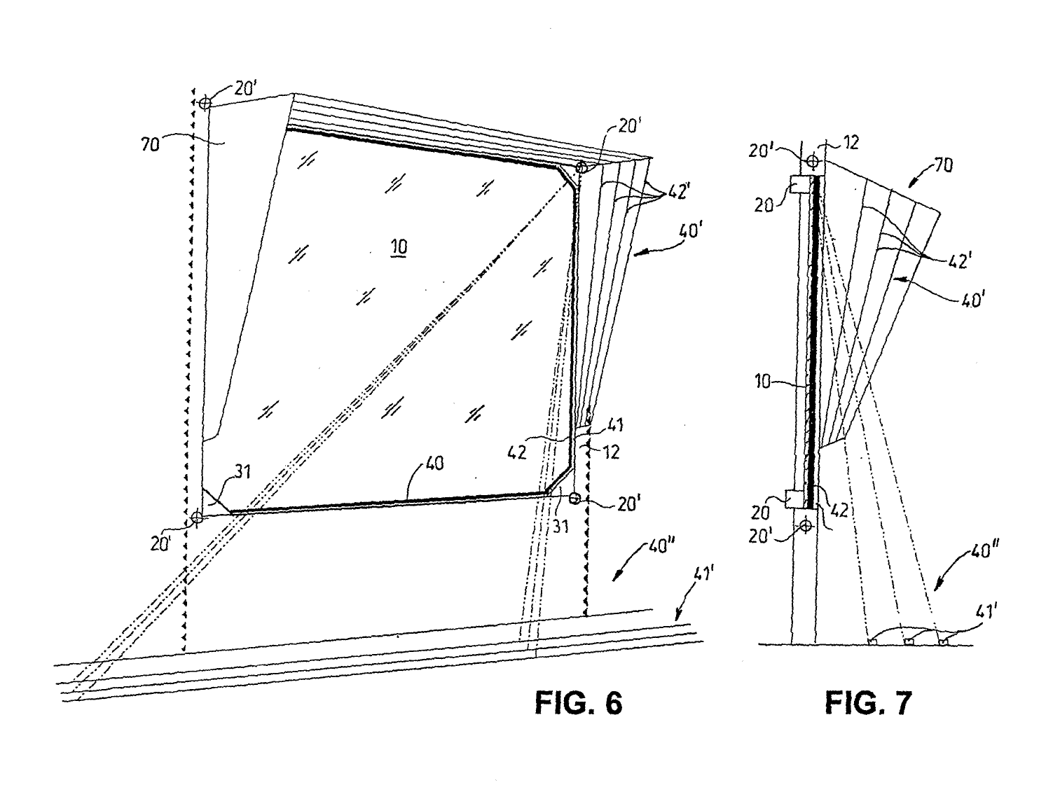

FIGS. 6 and 7 show a complex embodiment of the inventive solution providing quasi-3D function by using a more complex optical patterns 40′ and 42′. In conjunction with four imaging devices 20 arranged at the inner side of the transparent sheet 10 of the shop-window and each of them is combined with a (not depicted) mirror inside a mirror holder 31 located in a corresponding corner of the shop-window. These mirrors deflect the viewing field of imaging, devices 20 and this phenomenon results in imaginary imaging devices 20′ marked by encircled crosses at the corners of the shop-window. Such imaginary imaging devices 20′ capture images of optical patterns 40′ and 42′ arranged outside the transparent sheet 10. Optical pattern 40′ is provided on the inner side of a shade 70 partially surrounding the shop-window from above and laterally. The other optical pattern 40″ comprising metal profiles as bright stripes 41′ is partially embedded into the pavement in front of the shop-window. The transparent sheet is completely surrounded by the same optical pattern as in case of the system of FIG. 1.

The position of any object entering the area defined in cooperation by the apparent positions of said imaging devices 20 as seen from optical patterns 40, 40′ and 40″ corresponding to the positions of imaginary imaging devices 20′ can be defined by processing and evaluating the images captured by said imaging devices 20. By identifying also the plane intersected by the object allows also a limited or coarse evaluation of the distance of the intersection from the transparent sheet 10. The position of any close approach of the transparent sheet 10 can be determined with the same accuracy as in case of the system according to FIG. 1.

It is just obvious that the location of the imaginary imaging devices 20′ form heoretical planes in cooperation with the optical patterns 40, 40′ and 40″ and the images captured by imaging devices 20 can be evaluated by monitoring any changes of the images of the separate stripes 41, 42, 41′, 42′, more precisely of the bright-dark transitions thereof in contrast their environment.

The invented system can be completed also by a movement sensor for switching on the illumination of the shop-window or inducing some effect, e.g. starting a video or movement of displayed items. Further, the invented system can be used without any transparent sheet. In that case the imaging devices in conjunction with the optical patterns define a not necessarily planar surface, which is monitored by the invented system.

1. A method of determining an intrusion into a monitored area comprising the steps of capturing images of at least two imaging devices positioned at a deferent locations relative to said area and having overlapping fields of view covering the images of a predetermined pattern located behind said monitored area, processing the captured images to detect change in the image of the predetermined pattern to determine relative position of an object causing said change in the captured image of the predetermined pattern.

2. A method of claim 1, comprising the steps of arranging said predetermined patterns in parallel position on a first side of a transparent sheet material,
arranging said imaging devices on a second side of said transparent sheet material,
reflecting said images of said predetermined patterns through said transparent sheet material to said imaging devices.

3. A method of claim 2, comprising the steps of arranging said predetermined pattern at least along three lines at the periphery of a rectangular sheet of said transparent sheet material, said pattern comprises bright-dark transition having a longitudinal orientation along said pattern.

4. A method of claim 2, comprising the step of generating output signals depending on the determined relative position to cause a change perceptible from the first side of said transparent sheet material.

5. A method of claim 4, wherein said perceptible change is at least one of the events in a group comprising changing an image, starting the playback of a film or video, playing a sound, changing illumination conditions at least on one side of said transparent sheet material, moving at least one object located on the second side of said transparent material.

6. A method of claim 1, wherein while detecting change in the image of the predetermined pattern slow changes are neglected to eliminate consequences of influences caused by any variation either of ambient light illumination or staining of said predetermined pattern.

7. System for generating at least one output signal depending on the relative position of an intrusion of an optically detectible object into a monitored area, comprising at least two imaging devices spaced from the plane of said monitored area, and having fields of view covering the whole monitored area,
a predetermined optical pattern positioned essentially outside and behind said monitored area, as seen from said imaging devices,
at least two mirrors directing the images of said optical patterns to said imaging devices,
a processor receiving and processing image data provided by said at least two imaging devices to detect any optical change caused by the intrusion of said object into said monitored area and to determine the position of said intrusion causing optical change within said predetermined area,
an output signal generator for generating at least one output signal depending on the relative position of said intrusion into said monitored area.

8. The system of claim 7, wherein said optical pattern is arranged to enclose said monitored area.

9. The system of claim 7, wherein said optical pattern includes a line laying in the plane of said monitored area, said line, comprising a black and white transition

10. The system of claim 7, wherein at least four imaging devices are arranged around said monitored area, each having a viewing angle covering the whole monitored area from deferent locations.

11. The system of claim 10, wherein said optical patterns are arranged at all four sides of a rectangle and said monitored area is defined within said rectangle.

12. The system of claim 11, wherein at least two monitored areas are defined in different planes and optical patterns are arranged in each of such planes.

13. The system of claim 11, wherein at least two monitored areas are defined in different planes and mirrors are arranged in each of such planes.
